(19) United States
(12) Patent Application Publication
(10) Pub. No.: US 2026/0050818 A1
(43) Pub. Date: Feb. 19, 2026

(54) DEVICE, METHOD AND SYSTEM FOR ELECTRONICALLY REDUCING DEVIATIONS FROM COMPLIANCE METRICS

(71) Applicant: MOTOROLA SOLUTIONS, INC., Chicago, IL (US)

(72) Inventors: Jonathan Wai Choong CHAN, Bukit Mertajam (MY); Tze Voon TAN, Bukit Mertajam (MY); Wei Lun CHAN, Simpang Ampat (MY); Wei Jie TEOH, Bukit Mertajam (MY); Mariya BONDAREVA, Loxahatchee, FL (US)

(21) Appl. No.: 18/805,916

(22) Filed: Aug. 15, 2024

(51) Int. Cl. G06N 20/00

(52) U.S. Cl. CPC G06N 20/00

(57) ABSTRACT

A device receives sensor measurements associated with a location and inputs to a first trained model that processes given sensor measurements and outputs indications of deviations from compliance metrics in the given sensor measurements. An indication of such a deviation is received from the first model, and the device correlates with one or more database records associated with the location. The indication of the deviation and the database record(s) are input to a second trained model that processes the deviation and correlated database records, and outputs scores indicative of respective impact of the deviation on the correlated database records. Such a score is received from the second model, and when the score does not meet a given compliance threshold score, the device generates and/or updates an operational protocol to reduce the deviation, and electronically deploys the operational protocol, in association with the location, to reduce such deviations at the location.

### BACKGROUND OF THE INVENTION

Deviations from compliance metrics may cause undue stress on electronic systems. For example, when deviations from compliance metrics occur, such electronic systems may experience increased use of processing resources and/or bandwidth to address such deviations from compliance metrics. Furthermore, deviations from compliance metrics may result in the electronic system being rendered obsolete.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system for electronically reducing deviations from compliance metrics, in accordance with some examples.

FIG. 2 is a device diagram showing a device structure of a device for electronically reducing deviations from compliance metrics, in accordance with some examples.

FIG. 3 is a flowchart of a method for electronically reducing deviations from compliance metrics, in accordance with some examples.

FIG. 4 depicts the system of FIG. 1 implementing a method for electronically reducing deviations from compliance metrics, in accordance with some examples.

FIG. 5 depicts the system of FIG. 1 continuing to implement a method for electronically reducing deviations from compliance metrics, in accordance with some examples.

FIG. 6 depicts the system of FIG. 1 continuing to implement a method for electronically reducing deviations from compliance metrics, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Deviations from compliance metrics may cause undue stress on electronic systems due increased use of processing resources and/or bandwidth to address such deviations from compliance metrics. Furthermore when such deviations from compliance metrics occur repeatedly, an electronic system may be rendered obsolete. Thus, there exists a need for an improved technical method, device, and system for electronically reducing deviations from compliance metrics.

An aspect of the specification provides a method comprising: receiving, via at least one computing device, a plurality of sensor measurements associated with a given location; inputting, via the at least one computing device, the plurality of sensor measurements into a first trained model configured to process given sensor measurements and output indications of deviations from compliance metrics in the given sensor measurements; receiving, via the at least one computing device, from the first trained model, an indication of a deviation from the compliance metrics in the plurality of sensor measurements; correlating, via the at least one computing device, the indication of the deviation with one or more database records associated with the given location; inputting, via the at least one computing device, the indication of the deviation and the one or more database records into a second trained model configured to process the deviation from the compliance metrics and correlated database records, and output scores indicative of respective impact of the deviation on the correlated database records; receiving, via the at least one computing device, from the second trained model, a score indicative of impact of the deviation on the one or more database records; when the score does not meet a given compliance threshold score, one or more of generating and updating, via the at least one computing device, an operational protocol to reduce the deviation from the compliance metrics; and electronically deploying, via the at least one computing device, the operational protocol in association with the given location, to reduce the deviation from the compliance metrics at the given location.

An aspect of the specification provides a device comprising: a communication interface; a controller; and a computer-readable storage medium having stored thereon program instructions that, when executed by the controller, causes the controller to perform a set of operations comprising: receiving, via the communication interface, a plurality of sensor measurements associated with a given location; inputting the plurality of sensor measurements into a first trained model configured to process given sensor measurements and output indications of deviations from compliance metrics in the given sensor measurements; receiving, from the first trained model, an indication of a deviation from the compliance metrics in the plurality of sensor measurements; correlating the indication of the deviation with one or more database records associated with the given location; inputting the indication of the deviation and the one or more database records into a second trained model configured to process the deviation from the compliance metrics and correlated database records, and output scores indicative of respective impact of the deviation on the correlated database records; receiving, from the second trained model, a score indicative of impact of the deviation on the one or more database records; when the score does not meet a given compliance threshold score, one or more of generating and updating an operational protocol to reduce the deviation from the compliance metrics; and electronically deploying, via the communication interface, the operational protocol in association with the given location, to reduce the deviation from the compliance metrics at the given location.

Each of the above-mentioned embodiments will be discussed in more detail below, starting with example system and device architectures of the system in which the embodiments may be practiced, followed by an illustration of processing blocks for achieving an improved technical method, device, and system for electronically reducing deviations from compliance metrics.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions and/or program code and/or computer program code. These computer program instructions and/or program code may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions and/or program code may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions and/or program code may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Herein, reference will be made to engines, which may be understood to refer to hardware, and/or a combination of hardware and software (e.g., a combination of hardware and software includes software hosted at hardware such that the software, when executed by the hardware, transforms the hardware into a special purpose hardware, such as a software module that is stored at a processor-readable memory implemented or interpreted by a processor), or hardware and software hosted at hardware and/or implemented as a system-on-chip architecture and the like.

Further advantages and features consistent with this disclosure will be set forth in the following detailed description, with reference to the drawings.

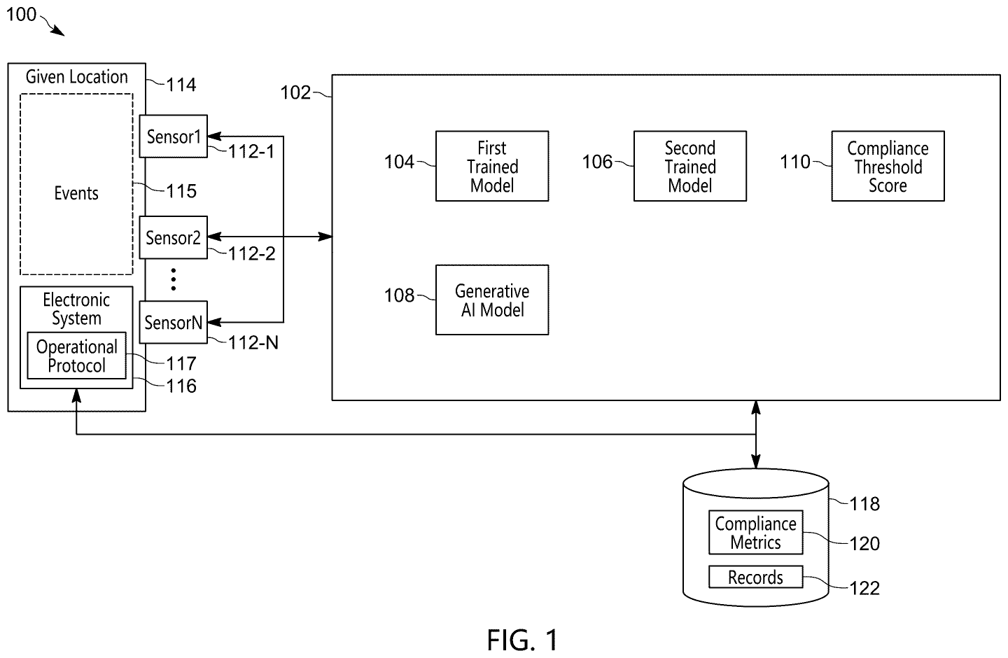

Attention is directed to FIG. 1, which depicts an example system 100 for electronically reducing deviations from compliance metrics. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like, unless otherwise indicated. However, to distinguish between flow of data and communication links between components in the present specification, the communication links are depicted as solid lines, while flow of data is depicted in broken lines.

The system 100 comprises at least one computing device 102 that may implement various models, and in particular a first trained model 104, a second trained model 106, and a generative artificial intelligence model 108, as well as maintain a compliance threshold score 110. Functionality related to the models 104, 106, 108, and the compliance threshold score 110 are described herein. Furthermore, the at least one computing device 102 is interchangeably referred to hereafter as the computing device 102.

The computing device 102 is communicatively coupled to a plurality of sensors 112-1, 112-2 . . . 112-N, interchangeably referred to hereafter, collectively, as the sensors 112 and, generically, as a sensor 112. This convention will be used throughout the present specification.

Furthermore, a number “N” of the sensors 112 may be as few as one sensor 112 (e.g., a first sensor 112-1), but may be any suitable number of sensors 112, such as two sensors 112 (e.g., the first sensor 112-1 and a second sensor 112-2), three sensors 112, ten sensors 112, or higher, amongst other possibilities. Indeed, an ellipsis between the second sensor 112-2 and the Nth sensor 112-N represents the system 100 comprising any suitable number of sensors 112-N that may be greater than the three depicted sensors 112.

The sensors 112 are generally associated with a given location 114 and are generally understood to generate sensor measurements associated with the given location 114. For example, the sensors 112 may comprise any suitable combination of cameras, video cameras, microphones, that monitor events 115, and the like that may occur at the given location 114 and/or in association with the given location. In some examples, the sensors 112 may comprise one or more text monitoring sensors that monitor textual indications of the events 115 associated with the given location 114. Hence, the sensor measurements generated by the sensors 112 may comprise one or more of video data, audio data, textual data, and the like.

While the sensors 112 are depicted as being at the given location 114, in some examples, for example when the sensors 112 comprise one or more text monitoring sensors, one or more of the sensors 112 may not be located at the given location, but may monitor events 115 associated with the given location 114 from a distance. For example, textual indications of the events 115 may comprise textual mentions of events 115 “on-line”, and the text monitoring sensors may detect such mentions. It is understood however, that monitoring of the events 115 that occur at the given location 114 may occur in real-time when sensors 112 are at the given location 114, but may not occur in real-time when sensors 112 are not at the given location 114.

Regardless, sensor measurements of the sensors 112 may represent the events 115 associated with the given location 114.

In particular, the computing device 102 is understood to be further communicatively coupled with an electronic system 116 associated with the given location 114. The electronic system 116 is generally configured to control the events 115 that occur at the given location 114, for example to reduce deviations from compliance metrics in sensor measurements that may represent the events 115 that occur at the given location 114. In general, the electronic system 116 may control the events 115 that occur at the given location 114 using an operational protocol 117, which may comprise programming instructions, for operating the electronic system 116 to control the events 115 that occur at the given location 114, and/or routines, and the like.

In particular, the electronic system 116 is understood to implement electronic actions, for example as indicated by the operational protocol 117, to be implemented in association with the given location 114 to control the aforementioned events 115, as will be described herein. For example, the electronic system 116 may be controlled to perform electronic actions that control the events 115, and/or the events 115 themselves may comprise electronic actions performed by the electronic system 116.

The computing device 102 is further communicatively coupled to a memory 118, which may be in the form of a database (as depicted), which stores the aforementioned compliance metrics 120 and a plurality of database records 122, interchangeably referred to hereafter, collectively, as the database records 122 and/or the records 122, and, generically and/or individually as a database record 122 and/or a record 122.

It is understood that the compliance metrics 120 and the database records 122 are generally associated with the given location 114.

The compliance metrics 120 may comprise a range of data that represents a range over which the sensor measurements of the sensors 112 are to be within for compliance. For example, the sensor measurements of the sensors 112 may be over a wide range, and only a portion of such a range may be located within the range of data represented by the compliance metrics 120. Hence, when the sensor measurements of the sensors 112 represent the events 115 associated with the given location 114, the sensor measurements complying with the compliance metrics 120, or not complying with the compliance metrics 120, may represent whether, or not, the events 115 themselves comply with the compliance metrics 120, at least by transitive association with the compliance metrics 120; for example, when the sensor measurements represent the events 115, and the sensor measurements are to be within a range of data represented by the compliance metrics 120, the sensor measurements complying, or not complying, with the compliance metrics 120 is understood to represent the events 115 complying, or not complying, with the compliance metrics 120.

Furthermore, while the term “range of data” is used to describe the compliance metrics 120 it is understood that the compliance metrics 120 may indicate and/or comprise any set of conditions, in any suitable manner, that indicate the sensor measurements of the sensors 112 being in compliance, or not in compliance.

It is further understood that some sensor measurements, and/or some events 115, may comply with the compliance metrics 120, while other sensor measurements, and/or other events 115, may not comply with the compliance metrics 120.

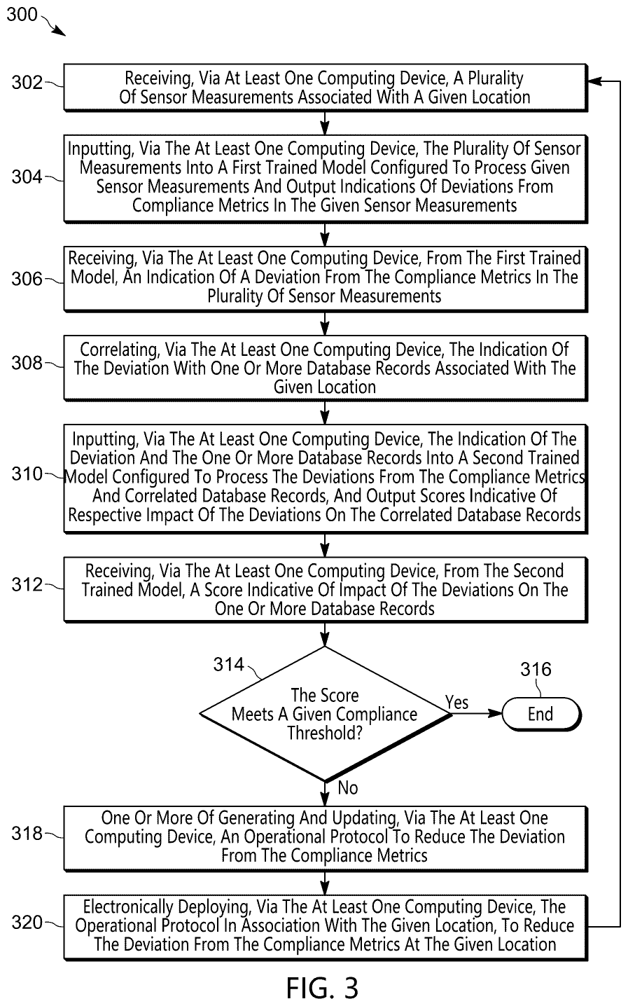

The records 122 are understood to represent the events 115. For example, a given record 122 may correspond to a given event 115. Hence, the records 122 may be used to determine whether, or not, changes to the electronic system 116 (e.g., changes to the operational protocol 117), also changes the events 115 over time, for example to better comply with the compliance metrics 120, as described herein at least with respect to FIG. 3 to FIG. 6.

Furthermore, the events 115 may generally relate to resource allocations at the given location 114, and hence corresponding records 122 may indicate such resource allocations, which may include, but is not limited to, allocations of memory and/or processing resources at the electronic system 116, which may, in some examples, relate to real world “macro” actions at the given location 114. Indeed, a record 122 may be generated and stored prior to an associated event 115 occurring, for example to allocate resources at the given location 114. An event 115 associated with a resource allocation may occur after the resource allocation.

It is understood that such events 115 are generally detectable by the sensors 112; hence, in some examples, one or more of the sensors 112 may be configured to detect events related to allocations of memory and/or processing resources at the electronic system 116, but which may manifest themselves as, and/or be associated with, real world macro” actions at the given location 114. For example, a memory allocation and/or processing resource allocation at the electronic system 116 may result in certain information being shown on a display screen, and/or provided via a speaker, at the given location 114, which may be detectable via a sensor 112 in the form of a video camera and/or a microphone. Indeed, such information may be in the form a visual depiction and/or aural depiction of a database record 122 at such a display screen and/or speaker, which may be updated to include other information about other real world “macro” actions at the given location 114. Alternatively, or in addition, a “macro” action at the given location 114 may include, but is not limited to, an interaction between individuals at the given location 114, with one or more of the individuals being associated with a resource allocation represented by a record 122. Indeed, a record 122 may include information identifying such one or more of the individuals.

It is further understood that while the system 100 is described with respect to one given location 114, the system 100 may comprise more than one given location 114, and the system 100 may hence comprise different locations, and electronic systems, operational protocols, sensors, records, compliance metrics, models and thresholds associated with the different locations. Put another way, the computing device 102 may implement functionality described herein for different locations, and operational protocols, compliance metrics, models and/or thresholds described herein may be customized for the different locations.

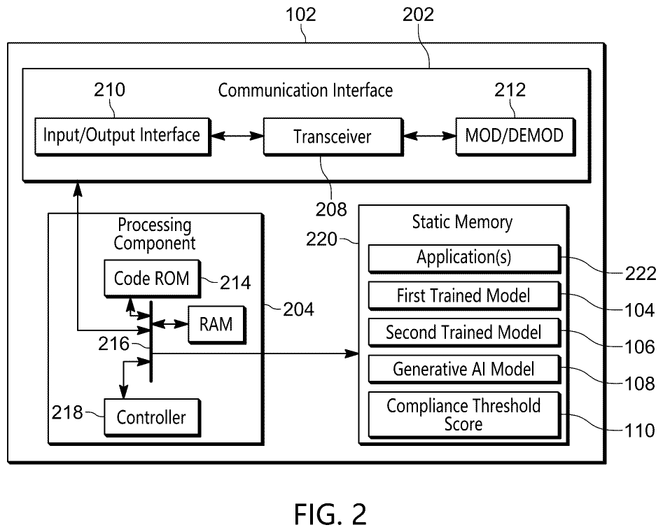

Attention is next directed to FIG. 2, which depicts a schematic block diagram of an example of the computing device 102. While the computing device 102 is depicted in FIG. 2 as a single component, the computing device 102 may be distributed among a plurality of components and the like including, but not limited to, any suitable combination of one or more servers, one or more cloud computing devices, and the like.

As depicted, the computing device 102 comprises: a communication interface 202, a processing component 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 102 may have any suitable structure and/or configuration.

As depicted, the memory 220 further stores the models 104, 106, 108, and the compliance threshold score 110. Alternatively, or in addition, one or more of the models 104, 106, 108 and/or the compliance threshold score 110 may be modules of the application 222.

In some examples, at least a portion of the memory 220 may comprise the memory 118, and/or one or more of the compliance metrics 120 and at least one of the records 122 may be stored at the memory 220. Put another way, while in FIG. 1 the memory 118 is depicted as external to the computing device 102, the memory 118 may be internal to the computing device 102 and/or the computing device 102 may store one or more of the compliance metrics 120 and at least one of the records 122 at the memory 220.

While not depicted, the computing device 102 may include, and/or be in communication with, one or more of an input component and a display screen (and/or any other suitable combination of input and/or output components) and the like.

As shown in FIG. 2, the computing device 102 includes the communication interface 202 communicatively coupled to the common data and address bus 216 of the processing component 204.

The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other suitable components of the system 100.

For example, the communication interface 202 may include one or more transceivers 208 and/or wireless transceivers for communicating with other suitable components of the system 100 such as the sensors 112, the electronic system 116 and the memory 118. Hence, the one or more transceivers 208 may be adapted for communication with one or more communication links and/or communication networks used to communicate with the other components of the system 100. For example, the one or more transceivers 208 may be adapted for communication with one or more of the Internet, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network.

Hence, the one or more transceivers 208 may include, but are not limited to, a cell phone transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the computing device 102 is not a generic controller and/or a generic device, but a device specifically configured to implement functionality for electronically reducing deviations from compliance metrics. For example, in some examples, the computing device 102 and/or the controller 218 specifically comprises a computer executable engine configured to implement functionality for electronically reducing deviations from compliance metrics.

The static memory 220 comprises a non-transitory machine readable medium that stores machine readable instructions to implement one or more programs or applications and/or program code. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 102 as described herein are maintained, persistently, at the memory 220 and used by the controller 218, which makes appropriate utilization of volatile storage during the execution of such programming instructions.

In particular, the memory 220 stores instructions and/or program code and/or a set of instructions corresponding to the at least one application 222 that, when executed by the controller 218, enables the controller 218 to implement functionality for electronically reducing deviations from compliance metrics, including but not limited to, the blocks of the method set forth in FIG. 3.

Put another way, the memory 220 may comprise a (e.g., non-transitory) computer-readable storage medium having stored thereon program instructions that, when executed by the controller 218, cause the controller 218 to perform a set of operations comprising the blocks of the method set forth in FIG. 3

The application 222 and/or one or more of the models 104, 106 may include programmatic algorithms, and the like, to implement functionality as described herein.

Alternatively, and/or in addition to programmatic algorithms, the application 222 and and/or one or more of the models 104, 106 may include one or more machine learning algorithms to implement functionality as described herein, for example identify users and/or objects and/or actions and/or associations in images.

The one or more machine learning algorithms of the application 222 and/or one or more of the models 104, 106 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Furthermore, in examples where the application 222 and/or the and/or one or more of the models 104, 106 includes one or more machine learning algorithms, the application 222 and/or the one or more of the models 104, 106 may be operated in a training mode to train the application 222 and/or the one or more of the models 104, 106 to implement the functionality described herein. For example, after implementing the method described with respect to FIG. 3, the input and output from the application 222 and/or the one or more of the models 104, 106 may be labelled as positive training data (e.g., when the output corresponds to a correct decision by the application 222 and/or the one or more of the models 104, 106) or negative training data (e.g., when the output does not correspond to a correct decision by the application 222 and/or the one or more of the models 104, 106), and used to train the application 222 and/or the one or more of the models 104, 106.

While components of the sensors 112 and the electronic system 116 are not depicted, the sensors 112 and the electronic system 116 may have a structure similar to that of the computing device 102, but adapted for respective functionality of the sensors 112 and the electronic system 116, as described herein.

Attention is now directed to FIG. 3, which depicts a flowchart representative of a method 300 for electronically reducing deviations from compliance metrics. The operations of the method 300 of FIG. 3 correspond to machine readable instructions that are executed by the controller 218 and/or at least one computing device 102. In the illustrated example, the instructions represented by the blocks of FIG. 3 are stored at the memory 220 for example, as the application 222 and/or the models 104, 106, 108. The method 300 of FIG. 3 is one way in which the controller 218 and/or the computing device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps. ” The method 300 of FIG. 3 may be implemented on variations of the system 100 of FIG. 1, as well.

At a block 302, the controller 218, and/or the at least one computing device 102, receives (e.g., via the communication interface 202) a plurality of sensor measurements associated with a given location 114.

For example, the plurality of sensor measurements may be received from one or more of the sensors 112, and the plurality of sensor measurements may comprise one or more of video data, audio data, and textual data.

At a block 304, the controller 218, and/or the at least one computing device 102, inputs the plurality of sensor measurements into a first trained model 104 configured to process given sensor measurements and output indications of deviations from compliance metrics 120 in the given sensor measurements.

For example, the first trained model 104 may comprise one or more machine learning models, one or more neural networks, one or more artificial intelligence models, and the like, and the first trained model 104 is understood to have been previously trained to output indications of deviations from compliance metrics 120 using given sensor measurements, and the compliance metrics 120, as input. Such training may occur in a training mode in which the first trained model 104 is provided with positive training data and/or negative training data. Positive training data may comprise sensor measurements that comply with the compliance metrics 120 (e.g., are in a range defined by the compliance metrics), and indications that indicate that the sensor measurements comply with the compliance metrics 120. Conversely, negative training data may comprise sensor measurements that do not comply with the compliance metrics 120 (e.g., are outside a range defined by the compliance metrics), and indications that indicate that the sensor measurements do not comply with the compliance metrics 120. For the training mode, positive or negative indications of whether, or not, sensor measurements comply, or do not comply, with the compliance metrics 120 may be generated manually or in any other suitable manner.

In some examples, it is assumed that the compliance metrics 120 may not change over time, and the first trained model 104 may be specifically trained based on the compliance metrics 120 not changing. In these examples, the compliance metrics 120 may not be used as input to the first trained model 104, whether or not the first trained model 104 is in a training mode. Rather, the sensor measurements may be used as input without the compliance metrics 120.

However, in other examples, it is assumed the compliance metrics 120 may change over time, and the first trained model 104 may be specifically trained using the compliance metrics 120 as an input, for example along with sensor measurements. In these examples, the compliance metrics 120 as input to the first trained model 104, whether or not the first trained model 104 is in a training mode, along with the sensor measurements.

Furthermore, it is understood that the compliance metrics 120 may be customized based on the given location 114. For example, the compliance metrics 120 may comprise a range of data (and/or conditions) that represents a range (and/or conditions) over which the sensor measurements of the sensors 112 are to be within for compliance, and such ranges (and/or conditions) may change depending on a location. Put another way, while the system 100 is described with respect to only one given location 114, the computing device 102 may be associated with a plurality of different given locations, and a different set of compliance metrics may be stored at the memory 118, or another memory, for two or more of the different given locations.

At a block 306, the controller 218, and/or the at least one computing device 102, receives, from the first trained model 104, an indication of a deviation from the compliance metrics 120 in the plurality of sensor measurements.

It is further understood that the indication of a deviation from the compliance metrics 120 in the plurality of sensor measurements may be for a plurality of events 115. Hence, some sensor measurements may deviate from the compliance metrics 120, while other sensor measurements may not deviate from the compliance metrics 120. It is hence understood that the indication of a deviation from the compliance metrics 120 in the plurality of sensor measurements may be for a plurality of events 115, and hence comprise a plurality of such indications, which may be time stamped and/or associated with sensor measurement time stamps, and the like, based on the sensor measurements used to determine the indications. For example, sensor measurements used as input to the first trained model 104 may be time stamped, and an associated indication may be associated with such time stamps. Such time stamps may indicate a date and time that sensor measurements were acquired.

Hence, it is furthermore understood that given sensor measurements may be input to the first trained model 104, when, and/or only when, the computing device 102 determines that the given sensor measurements are associated with an event 115. For example, one or more of the sensors 112 may include processing resources that may implement event detection engines (not depicted) configured to detect events 115 in respective sensor measurements, and may tag respective sensor measurements as being representative of an associated event 115. Alternatively, or in addition, the computing device 102 may be configured to detect events 115 in respective sensor measurements. Regardless, the computing device 102 may input given sensor measurements to the first trained model 104, when, and/or only when, the computing device 102 determines that the given sensor measurements are associated with an event 115, for example when the given sensor measurements are tagged as being representative of an associated event 115, and/or when the computing device 102 determines that the given sensor measurements represent an event 115. Alternatively, or in addition, the sensor measurements may be streamed to the computing device 102 and input to the first trained model 104.

It is furthermore understood that an indication of a deviation from the compliance metrics 120 in the plurality of sensor measurements may indicate a type of the deviation from the compliance metrics 120. Furthermore, in this example, the indication of a deviation from the compliance metrics 120 in the plurality of sensor measurements may identify aspects of the sensor measurements that deviate from the compliance metrics 120, and/or the indication of a deviation from the compliance metrics 120 in the plurality of sensor measurements may include portions of the sensor measurements that deviate from the compliance metrics 120. However, in these examples, such indications may be associated with a score that indicates a degree of such a deviation, for example on a scale of 0 to 1, or a scale of 0 to 100, and the like, with “0” representing a minimum deviation, and “1” or “100” representing a maximum deviation.

At a block 308, the controller 218, and/or the at least one computing device 102, correlates the indication of the deviation with one or more database records 122 associated with the given location 114.

For example, as has already been described, an indication of a deviation output by the first trained model 104 may be associated with a timestamp that may include a date and time of associated sensor measurements. Furthermore, a record 122 may be associated with a date and time, for example of associated resource allocations associated with the given location 114 and/or with the electronic system 116. Hence, a timestamp associated with an indication of a deviation may be used to correlate the indication of the deviation with a date and time of a record 122. For example, the controller 218, and/or the at least one computing device 102 may determine that an indication of a deviation and a record 122 that include a similar date and time are correlated.

Alternatively, or in addition, when the indication of the deviation includes a portion of associated sensor measurements, such a portion of the associated sensor measurements may include information that is similar to, or the same as, information in a record 122. For example, the controller 218, and/or the at least one computing device 102 may determine that an indication of a deviation and a record 122 that include similar and/or same information are correlated.

Alternatively, or in addition, an indication of a deviation may be associated with the sensor measurements used to generate the indication, and such sensor measurements may include information that is similar to, or the same as, information in a record 122. For example, the controller 218, and/or the at least one computing device 102 may determine that an indication of a deviation associated with sensor measurements and a record 122 that include similar and/or same information are correlated.

However, such correlations may be based on other criteria. For example, when a record 122 is determined to be correlated with an indication of a deviation, other, similar, records 122 may be correlated with the indication of the deviation. For example, such other, similar, records 122 may be associated with resource allocations at the given location 114 that are similar to a resource allocation of the record 122 is determined to be correlated with the indication of the deviation, but may not be associated with sensor measurements and/or indications of deviations. Put another way, while such other, similar, records 122 may not be associated with indications of deviations, as such other, similar, records 122 are determined to be similar to the record 122, that is determined to be correlated with an indication of a deviation, such other, similar, records 122 may be determined to be correlated with the indication of a deviation.

At a block 310, the controller 218, and/or the at least one computing device 102, inputs the indication of the deviation and the one or more database records 122 into a second trained model 106 configured to process the deviation from the compliance metrics 120 and correlated database records 122, and output scores indicative of respective impact of the deviation on the correlated database records 122.

Put another way, the second trained model 106 is understood to have been previously trained to receive, as input, deviations from the compliance metrics 120 and associated and/or correlated database records 122, and output scores indicative of respective impact of the deviations on the associated and/or correlated database records 122. When the second trained model 106 comprises one or more machine learning models, one or more neural networks, one or more artificial intelligence models, and the like, such training may occur in a training mode in which the second trained model 106 is provided with positive training data and/or negative training data. Positive training data may comprise indications of deviations from the compliance metrics 120 and database records 122 that correlate with the indications of deviations from the compliance metrics 120, as well as indicators that indicate the database records 122 correlate with the indications of deviations from the compliance metrics 120. Conversely, negative training data may comprise indications of deviations from the compliance metrics 120 and database records 122 that do not correlate with the indications of deviations from the compliance metrics 120, as well as indicators that indicate the database records 122 do not correlate with the indications of deviations from the compliance metrics 120.

Alternatively, or in addition, the second trained model 106 may comprise a programmatic algorithm configured to perform the respective functionality as described herein. In these examples, the second trained model 106 may be understood to be “trained” to perform the described functionality by virtue of programming of the second trained model 106.

Regardless, a score output by the second trained model 106 may be on a scale of 0 to 1, or 0 to 100, and the like, where “0” indicates a minimum impact of the deviation on the one or more database records 122, and “1” or “100” indicates a maximum impact of the deviation on the one or more database records 122.

However, in other examples, a score output by the second trained model 106 may represent a number of the correlated database records 122.

In yet other examples, a score output by the second trained model 106 may represent a value of the correlated database records 122. For example, a database record 122 may be associated with a given value, which may be in the form of a monetary value, which may include, but is not limited to, a monetary value for processing and/or maintaining a database record 122, amongst other possibilities.

Indeed, any suitable score is within the scope of the present specification, that is indicative of the respective impact of the deviations on the associated and/or correlated database records 122.

At a block 312, the controller 218, and/or the at least one computing device 102, receives, from the second trained model 106, a score indicative of impact of the deviation on the one or more database records 122.

For example, the indication of the deviation and/or an associated score may be input to the second trained model 106 along with any correlated database records 122, and the second trained model 106 may output a score indicative of impact of the deviation on the one or more database records 122.

At a block 314, the controller 218, and/or the at least one computing device 102, determines whether or not the score meets a given compliance threshold score 110.

When the score does meet the given compliance threshold score 110 (e.g., a “YES” decision at the block 314), the method 300 may end at a block 316, however the method 300 may be implemented periodically by the controller 218, and/or the at least one computing device 102.

When the score does not meet the given compliance threshold score 110 (e.g., a “NO” decision at the block 314), at a block 318, the controller 218, and/or the at least one computing device 102, one or more of generates and updates the operational protocol 117 to reduce the deviation from the compliance metrics 120.

For example, the given compliance threshold score 110 may represent a score above which the score output by the second trained model 106 is understood to represent a “high”impact of the deviation on the one or more database records 122. Similarly, the given compliance threshold score 110 may represent a score below which the score output by the second trained model 106 is understood to represent a “low” impact of the deviation on the one or more database records 122. While terms such as “high” and “low” are understood to be relative, the given compliance threshold score 110 may be selected, for example heuristically, to be a specific score that defines “high” and “low” impacts of deviations on the one or more database records 122. Using a scale for the score output by the second trained model 106 of “0” to “100”, the given compliance threshold score 110 may be selected to be “40”, “50”, “60”, amongst other possibilities.

In some examples, the given compliance threshold score 110, may depend on a type of impact of the deviation on the one or more database records 122. For example, the impact of the deviation on the one or more database records 122 may of a particular type, and the computing device 102 may store, or have access to, different given compliance threshold scores 110 associated with different types of impacts of deviations on the one or more database records 122. Such types of impacts may include, but are not limited to, a value impact, a frequency that deviation from the operational protocol 117 occurs in association with the one or more database records 122, and the like; hence, the given compliance threshold score 110 may include, but is not limited to, a value threshold score, a frequency of deviation threshold score, and the like. Indeed, any suitable compliance threshold score is within the scope of the present specification, and which may be determined heuristically.

Turning now to one or more of generating and updating the operational protocol 117, in some examples, a new operational protocol 117 may be generated that replaces the existing operational protocol 117. In other examples, an update may be generated that updates the existing operational protocol 117. In certain examples, the electronic system 116 may not initially include any operational protocol 117 that enables the electronic system 116 to control the events 115 that occur at the given location 114, and the block 318 may include generating a new operational protocol 117.

In general, the operational protocol 117 that is generated and/or updated at the block 318 may comprise programming instructions and/or routines that define electronic actions to be implemented in association with the given location 114, and that may be implemented by the electronic system 116.

In some examples, one or more of generating and updating the operational protocol 117 may occur using the generative artificial intelligence model 108, which may be configured as is next described.

For example, the generative artificial intelligence model 108 may be trained to receive given input and output an operational protocol and/or an update to an existing operational protocol. When updates are generated, the existing operational protocol may also be used as input to the generative artificial intelligence model 108; such examples assume that the computing device 102 has access to any existing operational protocol, which may be requested from the electronic system 116 and/or an existing operational protocol may be stored at the memory 118, for example when generated and/or updated.

The given input for the generative artificial intelligence model 108 may otherwise comprise one or more of: the sensor measurements used to generate the indication of the deviation of the block 306; the indication of the deviation of the block 306; and associated and/or correlated database records 122.

Furthermore, the generative artificial intelligence model 108 is understood to comprise any suitable generative artificial intelligence model trained to output an operational protocol, from the above described given inputs, for example in the form of programming instructions compatible for processing by the electronic system 116.

Hence, the operational protocol 117 may define electronic actions to be implemented in association with the given location 114, for example by the electronic system 116.

Furthermore, the operational protocol 117 may be customized based on the given location 114. For example, the compliance metrics 120 may be customized based on the given location 114, and, in such examples, the operational protocol 117 is understood to also be customized based on the given location 114, as the operational protocol 117 is generally to reduce the deviation from the compliance metrics 120

At a block 320, the controller 218, and/or the at least one computing device 102, electronically deploys (e.g., via the communication interface 202) the operational protocol 117 in association with the given location 114, to reduce the deviation from the compliance metrics 120 at the given location 114. The block 320 is understood to also occur when the score does not meet a given compliance threshold score 110 (e.g., a “NO”decision at the block 314).

From the block 320, the method 300 may repeat from the block 302 until the score meets the given compliance threshold score 110 (e.g., a “YES” decision at the block 314), though the method 300 may continue to repeat from the block 302 to ensure that the score continues to meet the given compliance threshold score 110.

For example, the method 300 may further comprise, the controller 218 and/or the at least one computing device 102, after electronically deploying the operational protocol 117: receiving a plurality of further sensor measurements associated with the given location 114; determining an updated score indicative of impact of the deviation from the compliance metrics 120 on the one or more database records 122 as determined using the plurality of further sensor measurements; and when the updated score does not meet the given compliance threshold score 110, updating the operational protocol 117 to reduce the deviation from the compliance metrics 120.

However, when the updated score meets the given compliance threshold score 110 the method 300 may end, or the method 300 may further comprise, the controller 218 and/or the at least one computing device 102, continuing to receive the plurality of further sensor measurements associated with the given location 114 and again determining the updated score, for example to continue to determine whether, or not, deviations from the compliance metrics 120 occur.

In general the method 300 may be repeated in a feedback loop until a score generated at the block 312 meets the given compliance threshold score 110, and thereafter the method 300 may end, or may be repeated periodically.

The method 300 may include other features.

The compliance metrics 120 may be dynamically updated, via the controller 218 and/or the at least one computing device 102, and/or any other suitable computing device 102.

In particular, the compliance metrics 120 may be dynamically updated based on one or more of: a plurality of further sensor measurements associated with the given location 114; and patterns and/or trends indicative of recurring deviations from the compliance metrics 120 associated with the given location 114 or changes to the deviations from the compliance metrics 120 associated with the given location 114.

Put another way, the patterns and/or trends indicative of recurring deviations from the compliance metrics 120 associated with the given location 114 may be determined over time based on a plurality of further sensor measurements associated with the given location 114.

For example, initially, for a given type of a deviation from the compliance metrics 120, only a small number of records 122 may be determined to be associated with a deviation from the compliance metrics 120, for example a number of records 122 that is less than a threshold record number. In these examples, the compliance metrics 120 may be updated to remove aspects of the compliance metrics 120 that define such deviations, for example to prevent the computing device 102 from determining such deviations.

However, such a determination may additionally, or alternatively, be based on rate of such deviations from the compliance metrics 120. For example, when a rate of such deviations is below a threshold rate, then the compliance metrics 120 may be updated to remove aspects of the compliance metrics 120 that define such deviations, for example to prevent the computing device 102 from determining such deviations.

Alternatively, or in addition, to update the compliance metrics 120, a range of data of the compliance metrics, that represents a range over which the sensor measurements of the sensors 112 are to be within for compliance, may be increased.

However, the converse may also be implemented. For example, a number of records 122 associated with a deviation from the compliance metrics 120 may increase over time to be above the aforementioned threshold record number, and/or such an increase may be greater than the aforementioned threshold rate. In these examples, a range of data of the compliance metrics, that represents a range over which the sensor measurements of the sensors 112 are to be within for compliance, may be decreased.

Alternatively, or in addition, a different type of deviation from the compliance metrics 120 may be detected by the computing device 102 in the sensor measurements. For example, certain types of sensor measurements that had been within a given range, may change over time to be outside the given range. In these examples, the computing device 102 may track how such sensor measurements change and determine a range within which the sensor measurements are to be located and such a range may be added to the compliance metrics 120 to indicate a new possible deviation from the compliance metrics 120.

Alternatively, or in addition, certain generic conditions of the compliance metrics 120 may indicate types of sensor measurements that may indicate generic deviations from the compliance metrics 120, which may include, but are not limited to, detecting certain gestures in video data and/or certain words in audio data and/or certain frequencies and/or changes in frequencies in the audio data. In these examples, a new type of deviation from the compliance metrics 120 may be detected by the computing device 102 in the sensor measurements, for example as indicated by a conversation between individuals detected in the sensor measurements, and the computing device 102 may update the compliance metrics 120 to indicate that, when such a new type of deviation occurs, non-compliance with the compliance metrics 120 is detected. Put another way, certain generic conditions of the compliance metrics 120 that are detected in the sensor measurements, may be used to determine specific conditions that are added to the compliance metrics 120 to indicate non-compliance (and/or conversely, to determine specific conditions that are added to the compliance metrics 120 to indicate compliance).

Alternatively, or in addition, the method 300 may further comprise, the controller 218 and/or the at least one computing device 102, training one or more of the first trained model 104 and the second trained model 106 in a feedback loop using the score indicative of the impact of the deviation on the one or more database records 122.

For example, in a training mode, the score indicative of the impact of the deviation on the one or more database records 122 may be used to train the first trained model 104, by using the score indicative of the impact of the deviation on the one or more database records 122 as training data in association with the sensor measurements used to generate an indication of a deviation (e.g., and optionally the compliance metrics 120). The score indicative of the impact of the deviation on the one or more database records 122 may generally indicate whether the indication of the deviation has a low impact on the database records 122, as indicated by a score of “0”, or whether the indication of the deviation has a high impact on the database records 122, as indicated by a score of “1” or “100”, (or the score may be in between).

However, in some examples, such training of the first trained model 104 may occur only when the score meets certain criteria, such as when the score is above 0.9 (on a scale of 0 to 1), or above 90 (on a scale of 0 100), or when the sore is below 0.1 (on a scale of 0 to 1), or below 10 (on a scale of 0 100).

Similarly, in examples where the second trained model 106 comprises one or more machine learning models and/or one or more neural networks and/or one or more artificial intelligence models, the score may be used to train the second trained model 106 in a manner similar to training the first trained model 104, but using the indication of a deviation and the correlated records 122. However, in some example, such training of the second trained model 106 may occur only when the score meets certain criteria, such as when the score is above 0.9 (on a scale of 0 to 1), or above 90 (on a scale of 0 100), or when the sore is below 0.1 (on a scale of 0 to 1), or below 10 (on a scale of 0 100).

Alternatively, or in addition, the method 300 may further comprise, the controller 218 and/or the at least one computing device 102, training the generative artificial intelligence model 108 in a feedback loop using the score indicative of the impact of the deviation on the one or more database records 122. However, such a feedback loop may occur with the previous operational protocol 117 before the previous operational protocol 117 is updated. For example, the score indicative of the impact of the deviation on the one or more database records 122, output by the second trained model 106, may indicate whether, or not, the previous operational protocol 117 was “good” or “not good”, and hence the previous operational protocol 117, along with the correlated records 122, sensor measurements and indications output by the first trained model 104 may be used as training data along with the score output by the second trained model 106. Such training of the artificial intelligence model 108 may occur only when the score meets certain criteria, such as when the score is above 0.9 (on a scale of 0 to 1), or above 90 (on a scale of 0 100), or when the sore is below 0.1 (on a scale of 0 to 1), or below 10 (on a scale of 0 100).

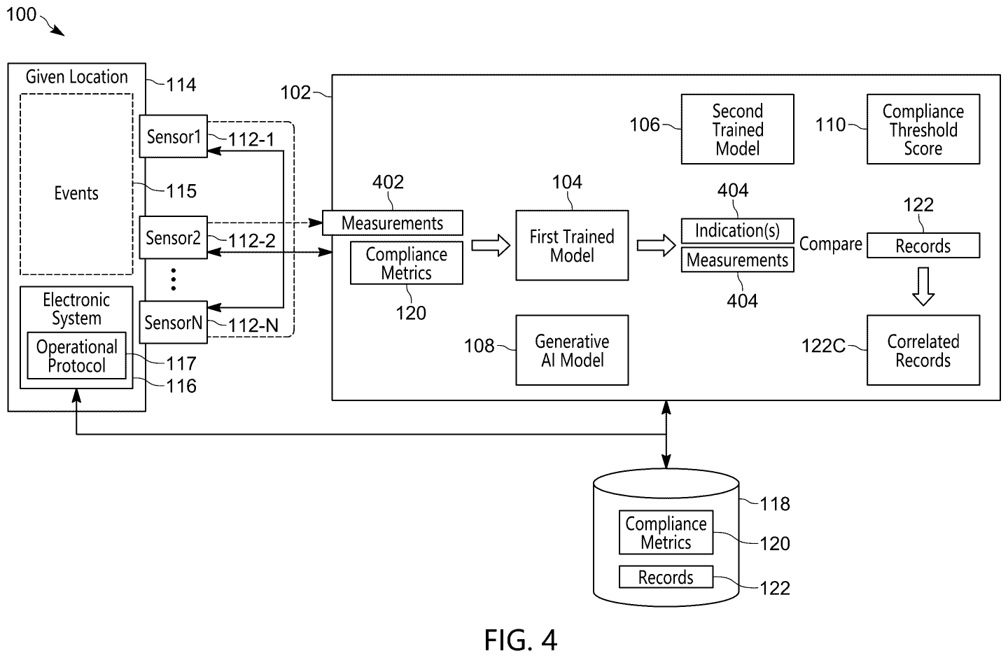

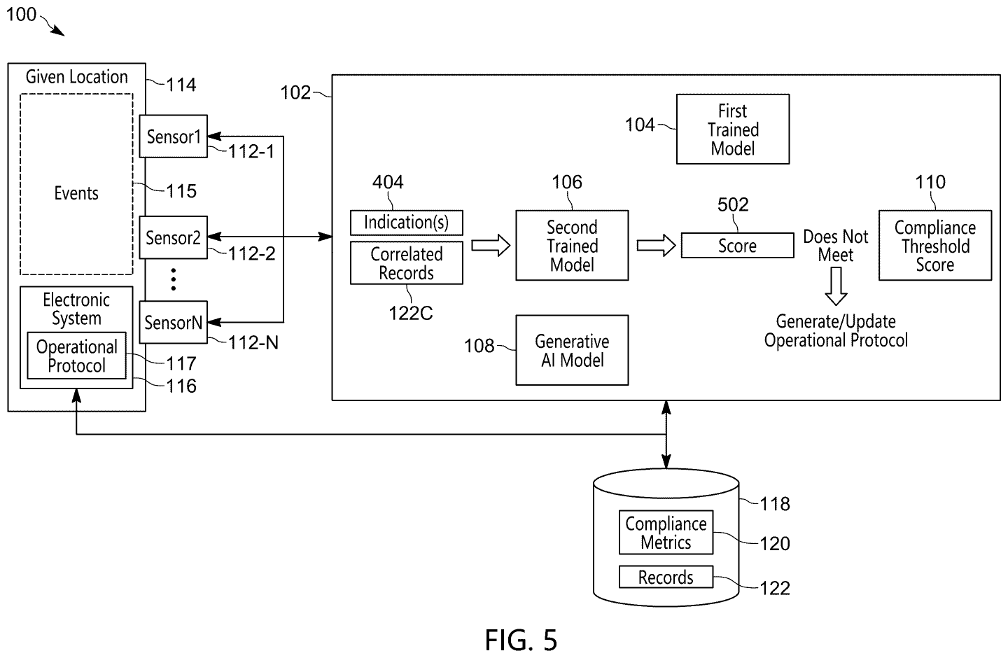

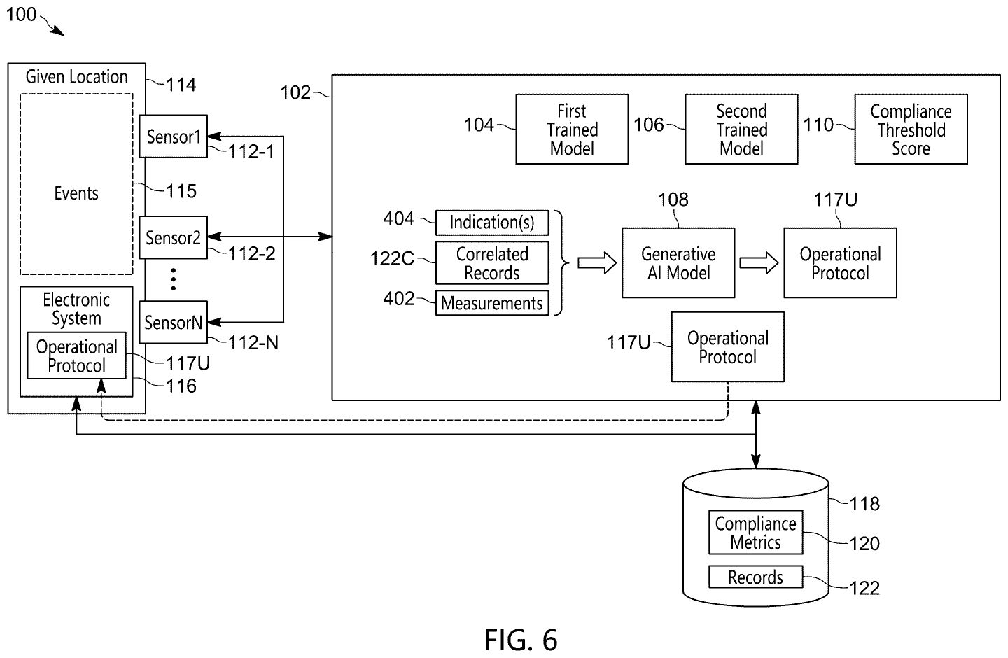

Aspects of the method 300 are next described with respect to FIG. 4, FIG. 5, FIG. 6, and FIG. 7, which are substantially similar to FIG. 1, with like components having like numbers. While not all aspects of FIG. 1 are depicted in FIG. 4, FIG. 5, FIG. 6, and FIG. 7, such aspects may nonetheless be present.

Attention is next directed to FIG. 4, which depicts the computing device 102 receiving (e.g., at the block 302 of the method 300) sensor measurements 402 from the sensors 112, which are input (e.g., at the block 304 of the method 300) to the first trained model 104, along with, as depicted, the compliance metrics 120, which may be retrieved from the memory 118.

Also in FIG. 4, the computing device 102 is depicted as receiving (e.g., at the block 306 of the method 300) an indication 404 (e.g., which may comprise more than one indication) of a deviation from the compliance metrics 120 in the sensor measurements 402.

Also depicted in FIG. 4, the computing device 102 compares the indication 404 and the associated sensor measurements 402 with the records 122 to determine (e.g., at the block 308 of the method 300) one or more of the records 122 that are correlated with the indication 404. Records 122 that are correlated, and/or associated with the indication 404 are referred to in FIG. 4, and hereafter, as the correlated records 122C.

Attention is next directed to FIG. 5, which depicts the computing device 102 inputting (e.g., at the block 310 of the method 300), the indication 404 of the deviation and the one or more correlated database records 122C into the second trained model 106.

Also in FIG. 5, the computing device 102 is depicted as receiving (e.g., at the block 312 of the method 300), from the second trained model 106, a score 502 indicative of the respective impact of the deviation on the correlated database records 122C.

Also in FIG. 5, the computing device 102 is depicted as comparing (e.g., at the block 314 of the method 300), the score 502 with the compliance threshold score 110. As depicted, the computing device 102 determines that the score 502 “Does Not Meet” the compliance threshold score 110 (e.g., a “NO” decision at the block 314 of the method 300), and hence determines that the operational protocol 117 is to be updated (e.g., and/or a new and/or updated operational protocol is to be generated), as indicated via text “Generate/Update Operational Protocol”, as is next depicted in FIG. 6.

In particular, in FIG. 6 the computing device 102 is depicted as generating (e.g., at the block 318 of the method 300) an updated operational protocol 117U to reduce the deviation from the compliance metrics 120. For example, as depicted, the computing device 102 may input any suitable combination of the indication 404, the correlated records 122C and the sensor measurements 402 into the generative artificial intelligence model 108, which outputs the updated operational protocol 117U. While not depicted, the computing device 102 may optionally input the existing operational protocol 117 into the generative artificial intelligence model 108.

Furthermore, as also depicted in FIG. 6, the computing device 102 electronically deploys (e.g., at the block 320 of the method 300) the updated operational protocol 117U in association with the given location 114, for example by providing the updated operational protocol 117U to the electronic system 116 associated with the given locations 114. The electronic system 116 processes and/or implements the updated operational protocol 117U, and the method 300 may repeat in a feedback loop until the score 502 meets the compliance threshold score 110.

For example, the electronic system 116, implementing the updated operational protocol 117U, may control future events 115 to reduce deviations from the compliance metrics 120.

In a particular example, a “macro” event as described herein may include a conversation between two individuals at the given location 114, which may comprise a hotel. A first individual may be a hotel employee and a second individual may be guest and/or a member of the public (e.g., that is not a hotel employee), referred to hereafter as the guest. The operational protocol 117 may define rules (e.g. such as rules in a standard operating procedure) to be provided by the electronic system 116 that instruct the hotel employee on interacting with guests, and the like, which the hotel employee may be following, but which may lead to a deviation from the compliance metrics 120.

For example, the guest may be angry with something said, or not said, by the hotel employee, or an action taken, or not taken, by the hotel employee, even though the hotel employee may have been following rules defined by the operational protocol 117. For example, the hotel employee may not be using a particular name of the guest, and the like, and/or the hotel employee may attempt to shake a hand of the guest, and the like. Such an indication that the guest is angry as indicated by the sensor measurements 402 may indicate a deviation from the compliance metrics 120 as is next described.

For example, a sensor 112 in the form of a microphone may generate sensor measurements 402 that is greater than a volume, as defined by the compliance metrics 120, and above which the sensor measurements 402 are not in compliance. Such a volume may generally indicate that the guest is angry.

Alternatively, or in addition, a sensor 112 in the form of a microphone may generate sensor measurements 402 that includes frequencies that are outside a compliance range defined by the compliance metrics 120. Such frequencies may generally indicate that the guest is angry.

Alternatively, or in addition, a sensor 112 in the form of a camera may generate sensor measurements 402 that includes images that depict gestures that meet conditions defined by the compliance metrics 120 that indicate the gestures are not in compliance. Such a gestures may generally indicate that the guest is angry.

Alternatively, or in addition, a sensor 112 in the form of a text monitoring sensor may be monitoring internet reviews of the hotel, for example on particular websites, and the like, and sensor measurements 402 generated by the text monitoring sensor may indicate that the guest was angry.

The sensor measurements 402 (and optionally the compliance metrics 120) may be input to the first trained model 104, and the first trained model 104 may output an indication 402 that the guest is angry with something said, or not said, by the hotel employee, or an action taken by the hotel employee, even though the hotel employee may have been following rules defined by the operational protocol 117 (e.g., such as using a particular name of the guest, and the like, and/or attempting to shake a hand of the guest, and the like).

Alternatively, or in addition, the operational protocol 117 may not indicate that employees should use preferred names of guests and/or the operational protocol 117 may include no indication about whether or not employees should shake hands with guests. Put another way, the guest may be angry for reasons that are not associated with rules, and the like, of the operational protocol 117.

Regardless, the sensor measurements 402 and the indication 402 may indicate that the guest is angry for particular reasons, and such an indication 402 that the guest is angry may indicate a deviation from the compliance metrics 120.

One or more data records 122 associated with the guest may be correlated with the deviation from the compliance metrics 120.

For example, based on an image of the guest in the sensor measurements 402, and/or a mention of the name of the guest in audio and/or text of the sensor measurements 402, the guest may be identified and associated and/or correlated data records 122 in the form of one or more hotel reservation records associated with the guest may be identified. For example, such data records 122 may indicate how often the guest stays at the hotel and/or associated hotels (e.g. other hotels in a same chain of hotels) and/or how much money the guest spends at the hotel /r associated hotels.

Alternatively, or in addition, a demographic and/or demographics of the guest may be identified from the sensor measurements 402. For example, the sensor measurements 402 may generally indicate an age of the guest, amongst other possible demographics (e.g. home city, country of origin, culture, sex, and the like). Regardless of type of demographic(s) of the guest that may be identified, database records 122 associated with guests of the same demographic(s) (e.g. a same age) and/or similar demographic(s) (e.g. an age range that includes the age of the guest) may be identified, which may include, but is not limited to, hotel reservations of other guests of the same and/or similar demographic(s). Such database records 122 may be designated as correlated database records 122c, which may indicate how often guests of the demographic(s) stay at the hotel and/or associated hotels, and/or how much money such guests spend at the hotel and/or associated hotels.

The indication 402 that the guest is angry, and the correlated database records 122c, may be input to the second trained model 106, which may output the score 502 indicative of respective impact of the deviation from the compliance metrics 120 on the correlated database records 122c.

For example, while the score 502 may be on scale of 0 to 1, or 0 to 100, the score 502 may generally indicate a financial impact on possible future reservations for the hotel and/or the hotel chain if the operational protocol 117 is not changed to: cause hotel employees to use preferred names of the guest and/or guests of the identified demographic(s); and/or cause hotel employees to stop attempting to shake hands with the guest and/or guests of the identified demographic(s).

For example, the higher a number of correlated database records 122c, the higher the score 502 may be. In particular, a number of correlated database records 122c may indicate how often the guest and/or guests of the identified demographic(s) stay at the hotel. Hence, when the number is “high”, as indicated by the score 502 not meeting the compliance threshold score 110, the score 502 may indicate that the guest and/or guests of the identified demographic(s) may not want to stay at the hotel and/or associated hotels in the future, which may decrease the number of future database records 122.

Similarly a financial value associated with the correlated database records 122c may indicate how much the guest and/or guests of the identified demographic(s) spends at the hotel. Hence, when the financial value is “high”, as indicated by the score 502 not meeting the compliance threshold score 110, the score 502 may indicate that the guest and/or guests of the identified demographic(s) may not want to stay at the hotel and/or associated hotels, which may decrease future financial value of such future database records 122.

Presuming the score does not meet the given compliance threshold score 110, the operational protocol 117 may be updated and/or changed to the updated operational protocol 117U to better define rules for the hotel employees to follow, that may prevent future guests, and the like, from getting angry when hotel employees are following such better defined rules.

For example, the updated operational protocol 117U may comprise programming instructions and/or routines for the electronic system 116, to control the electronic system 116 to provide updated rules, and/or an updated standard operating procedure, to cause hotel employees to use preferred names of guests, and/or to prevent hotel employees from shaking hands with guests that, for example, may be of a same and/or similar demographic as the guest associated with the deviation from the compliance metrics 120.

While this example is specific to a given macro event, it is understood that the method 300 generally comprises an electronic feedback loop to update the operational protocol 117.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot implement trained models, cannot process sensor measurements, cannot deploy operational protocols as programming instructions and/or routines, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions and/or program code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions and/or program code, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, via at least one computing device, a plurality of sensor measurements associated with a given location;
inputting, via the at least one computing device, the plurality of sensor measurements into a first trained model configured to process given sensor measurements and output indications of deviations from compliance metrics in the given sensor measurements;
receiving, via the at least one computing device, from the first trained model, an indication of a deviation from the compliance metrics in the plurality of sensor measurements;
correlating, via the at least one computing device, the indication of the deviation with one or more database records associated with the given location;
inputting, via the at least one computing device, the indication of the deviation and the one or more database records into a second trained model configured to process the deviation from the compliance metrics and correlated database records, and output scores indicative of respective impact of the deviation on the correlated database records;
receiving, via the at least one computing device, from the second trained model, a score indicative of impact of the deviation on the one or more database records;
when the score does not meet a given compliance threshold score, one or more of generating and updating, via the at least one computing device, an operational protocol to reduce the deviation from the compliance metrics; and
electronically deploying, via the at least one computing device, the operational protocol in association with the given location, to reduce the deviation from the compliance metrics at the given location.

2. The method of claim 1, further comprising, after electronically deploying the operational protocol:
receiving a plurality of further sensor measurements associated with the given location;
determining an updated score indicative of impact of the deviation from the compliance metrics on the one or more database records as determined using the plurality of further sensor measurements; and
when the updated score does not meet the given compliance threshold score, updating the operational protocol to reduce the deviation from the compliance metrics.

3. The method of claim 1, wherein the plurality of sensor measurements comprise one or more of video data, audio data, and textual data.

4. The method of claim 1, further comprising:
training one or more of the first trained model and the second trained model in a feedback loop using the score indicative of the impact of the deviation on the one or more database records.

5. The method of claim 1, wherein one or more of generating and updating the operational protocol occurs using a generative artificial intelligence model.

6. The method of claim 1, wherein the compliance metrics are customized based on the given location.

7. The method of claim 1, wherein the operational protocol is customized based on the given location.

8. The method of claim 1, wherein the given compliance threshold score is dependent on a type of the impact of the deviation on the one or more database records.

9. The method of claim 1, wherein the compliance metrics are dynamically updated based on one or more of: a plurality of further sensor measurements associated with the given location; and patterns or trends indicative of recurring deviations from the compliance metrics associated with the given location or changes to the deviation from the compliance metrics associated with the given location.

10. The method of claim 1, wherein the operational protocol comprises programming instructions that define electronic actions to be implemented in association with the given location.

11. A device comprising:
a communication interface;
a controller; and
a computer-readable storage medium having stored thereon program instructions that, when executed by the controller, causes the controller to perform a set of operations comprising:
receiving, via the communication interface, a plurality of sensor measurements associated with a given location;
inputting the plurality of sensor measurements into a first trained model configured to process given sensor measurements and output indications of deviations from compliance metrics in the given sensor measurements;
receiving, from the first trained model, an indication of a deviation from the compliance metrics in the plurality of sensor measurements;
correlating the indication of the deviation with one or more database records associated with the given location;
inputting the indication of the deviation and the one or more database records into a second trained model configured to process the deviation from the compliance metrics and correlated database records, and output scores indicative of respective impact of the deviation on the correlated database records;
receiving, from the second trained model, a score indicative of impact of the deviation on the one or more database records;
when the score does not meet a given compliance threshold score, one or more of generating and updating an operational protocol to reduce the deviation from the compliance metrics; and
electronically deploying, via the communication interface, the operational protocol in association with the given location, to reduce the deviation from the compliance metrics at the given location.

12. The device of claim 11, wherein the set of operations further comprises, after electronically deploying the operational protocol:
receiving a plurality of further sensor measurements associated with the given location;
determining an updated score indicative of impact of the deviation from the compliance metrics on the one or more database records as determined using the plurality of further sensor measurements; and
when the updated score does not meet the given compliance threshold score, updating the operational protocol to reduce the deviation from the compliance metrics.

13. The device of claim 11, wherein the plurality of sensor measurements comprise one or more of video data, audio data, and textual data.

14. The device of claim 11, wherein the set of operations further comprises:
training one or more of the first trained model and the second trained model in a feedback loop using the score indicative of the impact of the deviation on the one or more database records.

15. The device of claim 11, wherein one or more of generating and updating the operational protocol occurs using a generative artificial intelligence model.

16. The device of claim 11, wherein the compliance metrics are customized based on the given location.

17. The device of claim 11, wherein the operational protocol is customized based on the given location.

18. The device of claim 11, wherein the given compliance threshold score is dependent on a type of the impact of the deviation on the one or more database records.

19. The device of claim 11, wherein the compliance metrics are dynamically updated based on one or more of: a plurality of further sensor measurements associated with the given location; and patterns or trends indicative of recurring deviations from the compliance metrics associated with the given location or changes to the deviation from the compliance metrics associated with the given location.

20. The device of claim 11, wherein the operational protocol comprises programming instructions that define electronic actions to be implemented in association with the given location.
